(19) United States
(12) Patent Application Publication
(10) Pub. No.: US 2008/0240807 A1
(43) Pub. Date: Oct. 2, 2008

(54) BELT MEANDER PREVENTING DEVICE, FIXING DEVICE AND IMAGE FORMING APPARATUS HAVING THE SAME

(75) Inventors: Dong-woo Lee, Seoul (KR); Hwan-guem Kim, Seoul (KR); Tae-gyu Kim, Hwaseong-si (KR); Su-ho Shin, Seongnam-si (KR); Chang-hoon Jung, Seoul (KR); Hwan-hee Kim, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/862,513

(22) Filed: Sep. 27, 2007

(30) Foreign Application Priority Data
Mar. 28, 2007 (KR) 2007-30412

(51) Int. Cl. G03G 15/20

(52) U.S. Cl. 399/329

(57) ABSTRACT

A fixing device includes a fixing roller, a fixing belt which is made to rotate by a rotation force transferred from the fixing roller, a heat source which is mounted inside the fixing belt, a guide member, which is mounted inside the fixing belt, to guide the rotation of the fixing belt, and a belt meander preventing unit, which is mounted on the guide member, to elastically support both sides of the fixing belt and to prevent the fixing belt from meandering. Therefore, the sides of the fixing belt are elastically supported to gently absorb a reaction force acting on the end portion of the fixing belt, and accordingly it is possible to prevent the fixing belt from being damaged and meandering.

### CROSS-REFERENCE TO RELATED APPLICATIONS

This application claims priority under 35 U.S.C. §119 (a) of Korean Patent Application No. 10-2007-0030412, filed on Mar. 28, 2007, in the Korean Intellectual Property Office, the disclosure of which is incorporated herein by reference in its entirety.

### BACKGROUND OF THE INVENTION

1. Field of the Invention

The present general inventive concept relates to an image forming apparatus, and more particularly, to a belt-type fixing device and an image forming apparatus having the fixing device.

2. Description of the Related Art

Image forming apparatuses, such as printers, copiers, scanners, multi-function machines and the like, include fixing devices which press and fix developer images, such as toner images, which are transferred onto printing media, namely sheets of paper, by transferring devices, which are known to those skilled in the art.

FIG. 1 is a view schematically illustrating a conventional belt-type fixing device.

The conventional belt-type fixing device of FIG. 1 includes a pressing roller 10, a fixing belt 20 to rotate by a rotation force transferred from the pressing roller 10, a guide member 30 mounted inside the fixing belt 20 to guide the rotation of the fixing belt 20, and a heat source 40 to apply heat to a nip zone N of the fixing belt 20. The conventional belt-type fixing device configured as described above applies heat and pressure to a non-fixed toner image transferred onto a surface of a sheet of paper P by a transferring device, which is known to those skilled in the art, while the sheet of paper P passes through the nip zone N formed by pressure contact between the pressing roller 10 and the fixing belt 20 which rotate in contact with each other, and then fuses the toner image onto the sheet of paper P.

However, in the conventional belt-type fixing device configured as described above, the fixing belt 20 may come into irregular contact with the guide member 30 while rotating, and accordingly the fixing belt 20 may be moved along the axis of the guide member 30 due to the irregular contact, that is, may meander.

To solve this problem, a fixing device having a belt meander preventing function, as illustrated in FIG. 2, is already widely known to those skilled in the art. Specifically, each meander preventing projection 50 is secured to both ends of the guide member 30 to guide the rotation of the fixing belt 20, and accordingly the meander preventing projection 50 prevents the fixing belt 20 from being moved along the axis of the guide member 30, that is, from meandering.

However, in a fixing device having a belt meander preventing function configured as described above, excessive shock may be applied to the end portion of the fixing belt 20 while both sides of the fixing belt 20 bumps into the meander preventing projections 50, which may cause the fixing belt 20 to be crushed or even broken.

### SUMMARY OF THE INVENTION

The present general inventive concept provides a fixing device capable of preventing a fixing belt from meandering and being damaged.

The present general inventive concept provides an image forming apparatus having the fixing device described above.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a fixing device including a fixing roller, a fixing belt to rotate by a rotation force transferred from the fixing roller, a heat source mounted inside the fixing belt, a guide member mounted inside the fixing belt to guide the rotation of the fixing belt, and a belt meander preventing unit mounted on the guide member to elastically support both sides of the fixing belt and to prevent the fixing belt from meandering.

The belt meander preventing unit may include one or more meander preventing rollers which are mounted on one or both ends of the guide member; and an elastic member to elastically press the one or more meander preventing rollers towards the center of the fixing belt.

The one or more meander preventing rollers may include one of a rib and a tab protruding from an outside surface thereof to prevent the fixing belt from meandering.

The one or more meander preventing rollers may move at fixed intervals around an axis of a certain portion of the guide member.

The one or more meander preventing rollers may be rotatably mounted on a certain portion of the guide member.

The one or more meander preventing rollers may be arranged symmetrically or asymmetrically on an outer surface of a certain portion of the guide member.

The guide member may include one or more guide rollers mounted thereon to rotate in contact with an inside surface of the fixing belt.

The guide member may include a nip forming unit to support the fixing belt so that a nip zone may be formed in a contact area between the fixing roller and the fixing belt.

The nip forming unit may be formed of an elastic body with a predetermined elasticity, and may include, for example, a nip spring.

The nip spring may be made of a metallic material.

The nip spring may be integrally engaged with the guide member using a fastener.

The fastener may include a plurality of fasteners disposed at fixed intervals along the axis of the guide member.

The fastener may be one of a screw and a clip.

The heat source may be disposed on either or both the inside and the outside of the nip spring.

The fixing device may further include a heat insulating member mounted between the nip spring and the guide member.

The fixing roller may be a pressing roller.

The foregoing and/or other aspects and utilities of the present general inventive concept may also be achieved by providing a fixing device usable with an image forming apparatus, including a pressing roller; a fixing belt which is made to rotate by a rotation force transferred from the pressing roller; a heat source which is mounted inside the fixing belt; and a belt meander preventing unit to elastically support both sides of the fixing belt and to prevent the fixing belt from meandering.

The foregoing and/or other aspects and utilities of the present general inventive concept may also be achieved by providing an image forming apparatus including a photoconductive drum; a developing device to attach a developer onto an electrostatic latent image on the photoconductive medium and to develop the electrostatic latent image; a transferring device to receive and transfer an image developed on the photosensitive medium by the developing device to a printing medium; and a fixing device, as described above, to fix the image transferred to the printing medium.

The foregoing and/or other aspects and utilities of the present general inventive concept may also be achieved by providing a fixing device usable with an image forming apparatus, including a guide member to guide a fixing belt to rotate in a circumferential direction of an axis, and a belt meander preventing device disposed to rotate with respect to the guide member, to guide the fixing belt to rotate in the circumferential direction of the rotation axis, and to guide the fixing belt to rotate in a direction of the axis.

The foregoing and/or other aspects and utilities of the present general inventive concept may also be achieved by providing a fixing device usable with an image forming apparatus, including a guide member to guide a fixing belt to rotate along a rotation path in a circumferential direction of an axis thereof, and a belt meander preventing device having a roller rotatably disposed with respect to the guide member to guide the fixing belt in a direction of the axis.

The belt meander preventing device may include a shaft rotatably mounted on the guide member; and the roller is connected to the shaft.

The roller may include a rib to protrude from a surface thereof by a distance more than a thickness of the fixing belt in a radial direction of the axis to prevent the fixing belt from meandering.

The belt meander preventing device may further include a fixing bracket, and an elastic member disposed between the roller and the fixing bracket to elastically support the roller in a direction of the axis with respect to one of the fixing bracket and the guide member.

The guide member may include a portion to support the fixing bracket with respect to the belt meander preventing device

The image forming apparatus may include a housing on which the fixing bracket is mounted, and the elastic member is connected between the fixing bracket and the roller to bias the roller toward the fixing belt such that the fixing belt is prevented from being shifted from the rotation path.

The belt meander preventing device may include a plurality of belt meander preventing sub-devices disposed at different positions with respect to the guide member.

The fixing device may further include a heat source disposed on a stationary position of the guide member to supply heat to a nip of the fixing belt, and the belt meander preventing device may be rotatably disposed at another position with respect to the guide member to support the fixing belt to rotate in the circumferential direction.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a view schematically illustrating a conventional belt-type fixing device;

FIG. 2 is a perspective view illustrating a belt guide member of the conventional belt-type fixing device illustrated in FIG. 1;

FIG. 3 is a view schematically illustrating a fixing device usable with an image forming apparatus according to an exemplary embodiment of the present general inventive concept;

FIG. 4 is a view schematically illustrating a belt guide member of the fixing device illustrated in FIG. 3;

FIG. 5 is a perspective view illustrating a belt meander preventing unit illustrated in FIG. 4;

FIGS. 6A to 6C are views schematically illustrating various arrangements of a meander preventing roller according to an exemplary embodiment of the present general inventive concept;

FIGS. 7A and 7B are views schematically illustrating various fastening structures of a nip spring according to an exemplary embodiment of the present general inventive concept;

FIG. 8 is a view schematically illustrating an example of an image forming apparatus including a fixing device according to an exemplary embodiment of the present general inventive concept; and

FIG. 9 is a graph illustrating a difference between the meander preventing effect of a fixing device according to an exemplary embodiment of the present general inventive concept and a conventional fixing device.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

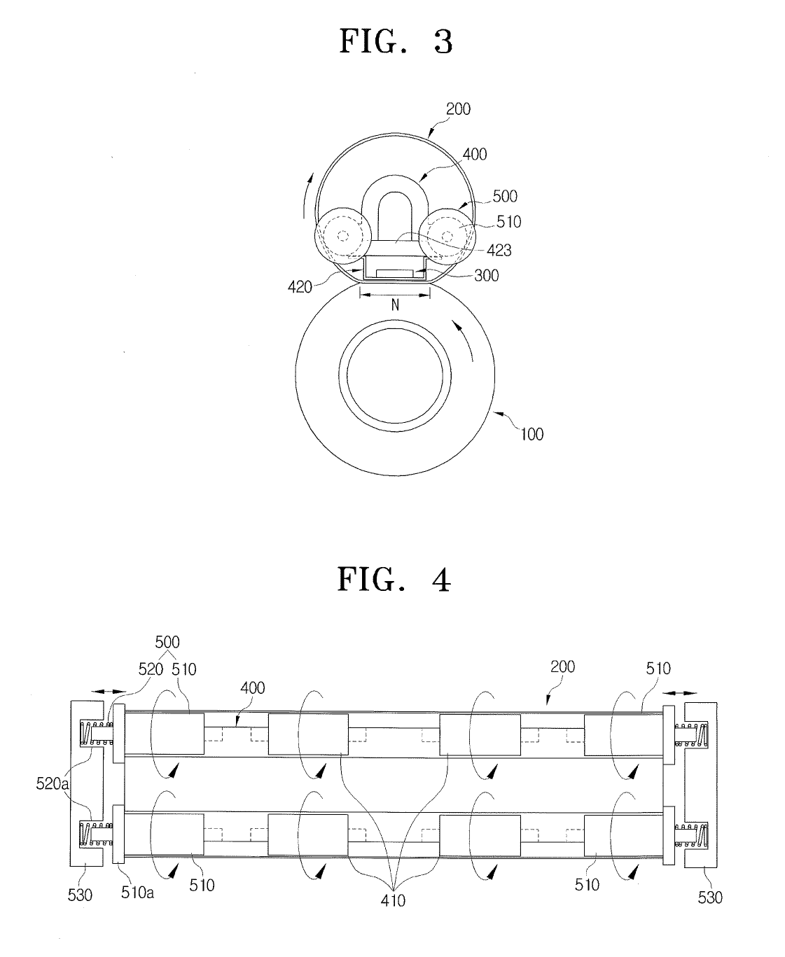

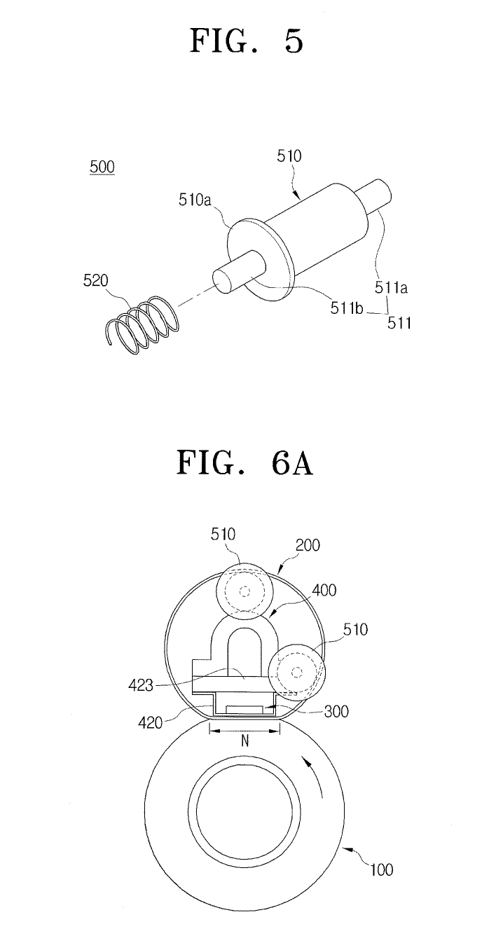

FIG. 3 is a view schematically illustrating a fixing device usable with an image forming apparatus according to an exemplary embodiment of the present general inventive concept, FIG. 4 is a view schematically illustrating a belt guide member of the fixing device illustrated in FIG. 3, and FIG. 5 is a perspective view illustrating a belt meander preventing unit illustrated in FIG. 4.

As illustrated in FIGS. 3 to 5, the fixing device according to an exemplary embodiment of the present general inventive concept includes a fixing roller 100, a fixing belt 200, a heat source 300, a guide member 400, and a belt meander preventing unit 500.

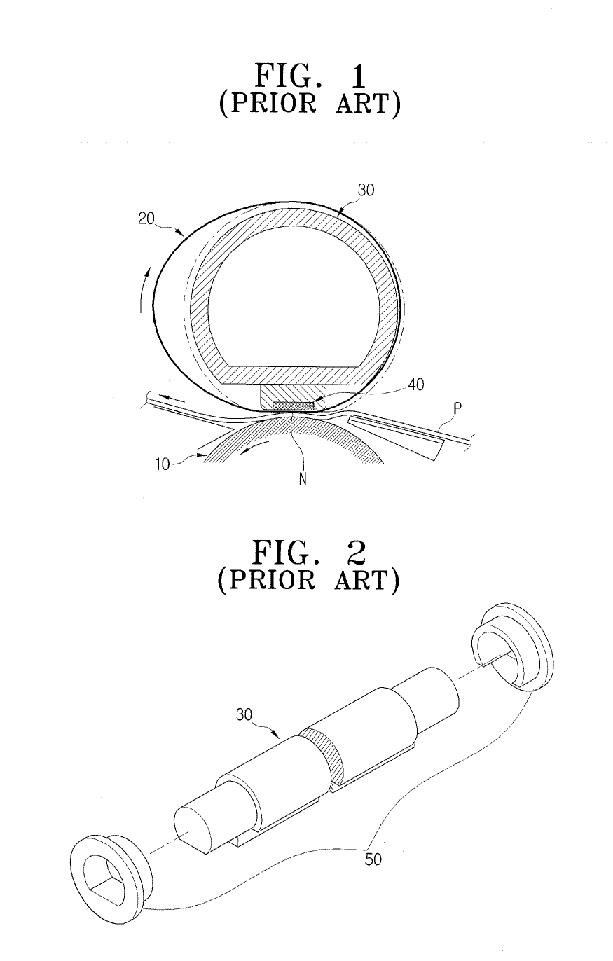

The fixing roller 100 may be a pressing roller 100 (hereinafter, indicated by reference numeral 100), which receives a driving force and rotates thereby, in order to press a toner image onto a printing medium, for example, a sheet of paper P (referring to FIG. 1), and to fix the toner image onto the printing medium. The pressing roller 100 may be long and cylindrical in shape.

The fixing belt 200 may be rotated by a rotation force received from the pressing roller 100, and a nip N may be formed between the pressing roller 100 and the fixing belt 200. The nip N refers to an area in which the sheet of paper P is held between a contact area of the pressing roller 100 and the fixing belt 200. The fixing belt 200 may be shaped as a belt with a width corresponding to a length of the pressing roller 100 along a rotation axis thereof, and may have a regular elastic force in order to rotate smoothly. A constant pressurizing force necessary for fixing a toner image onto the sheet of paper P may exist between the pressing roller 100 and the fixing belt 200. The fixing belt 200 rotates together with the pressing roller 100 as described in accordance with the exemplary embodiment of the present general inventive concept above, but a separate driving device may be used to rotate the fixing belt 200 instead of the pressing roller 100.

The heat source 300 may be mounted inside the fixing belt 200, may receive a power source from an outside thereof, and may generate and simultaneously transfer at least a portion of heat to the nip N. The heating source 300 may be variously implemented as a lamp heater, a heating coil or the like.

Although not illustrated in FIG. 2, the fixing device may include a temperature sensor to detect the temperature of the heat source 300, and a temperature controller to control the temperature of the heat source 300 which is detected by the temperature sensor. The temperature controller may adjust power to be supplied to the heat source 300 to control or change the temperature.

The guide member 400 may have an elongated shape, and may be longitudinally disposed within the fixing belt 200 to guide the rotation of the fixing belt 200. The guide member 400 includes one or more guide rollers 410 which rotate in contact with an inside surface of the fixing belt 200. The guide rollers 410 may be variously arranged, for example, symmetrically or asymmetrically on an outer surface of a certain portion of the guide member 400, and may be rotatably mounted on the guide member 400. The guide rollers 410 may be disposed symmetrically on both sides of the guide member 400. The guide member 400 includes a nip forming unit 420 to support the fixing belt 200 so that a nip zone N can be formed at a contact area between the fixing roller 100 and the fixing belt 200. The nip forming unit 420 may transfer heat exerted by the heat source 300 to the nip zone N of the fixing belt 200, and may protect the heat source 300 disposed inside the nip forming unit 420. The nip forming unit 420 may be formed of an elastic body with a predetermined elasticity, for example, a nip spring 420 (hereinafter, indicated by reference numeral 420), so that the pressurizing force acting on the pressing roller 100 can be adjusted. The nip spring 420 may be made of a metallic material. The nip spring 420 may be elastically deformed so that a side surface thereof opposite the pressing roller 100 can have a curved surface fitted on an outside surface of the pressing roller 100. Although not illustrated in FIG. 2, the nip spring 420 may include a projection formed on an outside bottom surface thereof, so that sheets of paper can be easily fed and discharged and jamming of the sheets can be prevented. Additionally, the heat source 300 may be disposed on either or both the inside and the outside of the nip spring 420, and may be placed on an inside bottom surface of the nip spring 420. Accordingly, the heat source 300 may partially apply heat to the nip zone N and areas neighboring the nip zone N, and thus it is possible to reduce an initial preheating time.

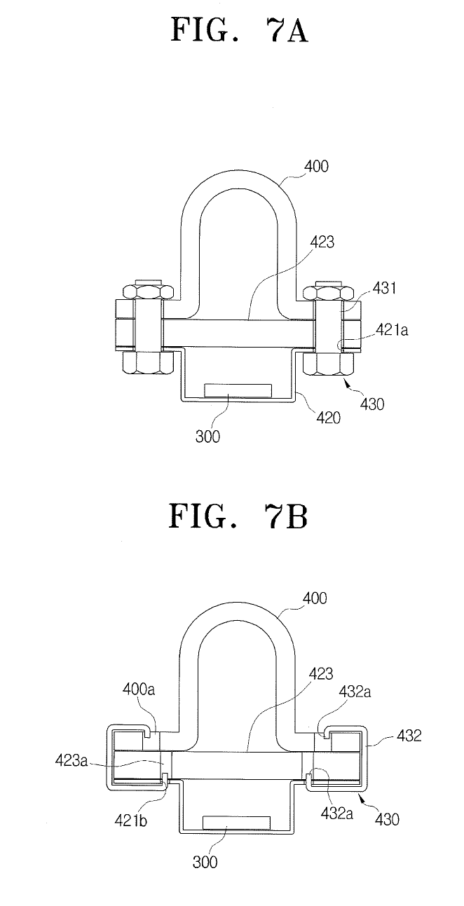

A heat insulating member 423 may be mounted between the guide member 400 and the nip spring 420 in order to prevent the heat exerted by the heat source 300 from being transferred to the guide member 400 through the nip spring 420. The nip spring 420 may be integrally engaged with the guide member 400 and the heat insulating member 423 using a fastener 430. For example, referring to FIG. 7A, the nip spring 420 may be securely fastened to the guide member 400 and the heat insulating member 423 using a screw 431. At this time, the nip spring 420 may be deformed by the heat from the heat source 300, so a diameter of a screw hole 421 a formed in the nip spring 420 may be slightly greater than that of the screw 431. Additionally, referring to FIG. 7B, the nip spring 420 may be securely fastened to the guide member 400 and the heat insulating member 423 using a clip 432. The clip 432 may be formed in various shapes, for example, a “U” shape partially enclosing each end portion of the nip spring 420, the guide member 400 and the heat insulating member 423. The clip 432 may include a locking tab 432a formed at both end portions thereof so that the locking tab 432a can lock into and be engaged in locking holes 421 b, 400a and 423a which are formed on the nip spring 420, the guide member 400 and the heat insulating member 423, respectively.

The belt meander preventing unit 500 may be mounted on the guide member 400 in order to elastically support both sides of the fixing belt 200 and to prevent the fixing belt 200 from meandering. The belt meander preventing unit 500 includes a meander preventing roller 510 and an elastic member 520.

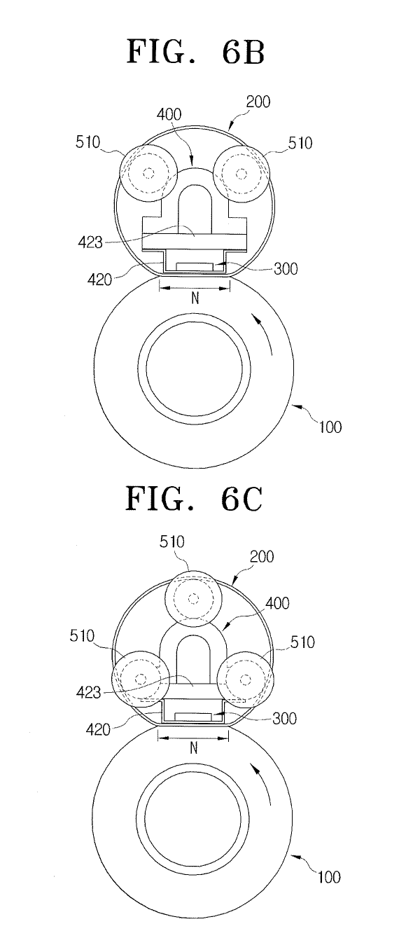

A meander preventing roller 510 may be mounted on one or both ends of the guide member 400. The meander preventing roller 510 includes a rib 510a or a tab (not illustrated) to prevent a belt from meandering, and the rib 510a or the tab may protrude from an outside surface of the meander preventing roller 510. The meander preventing roller 510 also includes a rotation shaft 511, and a first end 511a of the rotation shaft 511 may be inserted into and/or supported by a groove (not illustrated) provided at a certain portion of the guide member 400 so that the rotation shaft 511 may be rotatably mounted. The meander preventing rollers 510 may move around an axis of a certain portion of the guide member 400. The meander preventing roller 510 may include a plurality of meander preventing rollers 510 may be variously arranged, symmetrically or asymmetrically, on an outer surface of a certain portion of the guide member 400. For example, as illustrated in FIGS. 6A to 6C, the plurality of meander preventing rollers 510 may be arranged asymmetrically on an upper side and a left side or right side of the guide member 400, or arranged symmetrically on both the upper left side and upper right side of the guide member 400, or arranged on the upper, left and right sides of the guide member 400, on the outer surface of a certain portion of the guide member 400. The plurality of meander preventing rollers 510 may have various arrangements other than those listed here.

Accordingly, the guide member 400 guides the fixing belt 200 to rotate along a rotation path in a circumferential direction of an axis according to a rotation force of the press roller 100, and the belt meander preventing unit 500 prevents the fixing belt 200 from moving away from the rotation path in an axial direction different from the circumference direction. Here, the guide member 400 may not have a portion to guide the fixing belt 200 in an area other than the nip N, as an exemplary embodiment. Although the axis may not be in a fixed position since the fixing belt 200 is not a fixed shape in the area during rotation in the circumferential direction, the axis is disposed inside of the fixing belt 200, that is, inside of the circumferential direction. The axial direction may be an axis perpendicular to the circumferential direction of the fixing belt 200, an axis of the guide member 300, a rotation axis of the rotation shaft 511, or an axis having an angle with the circumferential direction. The fixing belt 200 is prevented from being shifted from the rotation path of the fixing belt 200.

The meander preventing rollers 510 are rotatably mounted on the guide member 400, and rotate according to a rotation of the fixing belt 200 with respect to the guide member 400. Accordingly, the meander preventing rollers 510 includes a first portion to guide a rotation of the fixing belt 200 along the rotation path, and a second portion disposed to guide the rotation of the fixing belt 200 along the rotation path and to prevent the fixing belt 200 from moving away from the rotation path, so that a side portion of the fixing belt 200 is not disposed outside of the rotation path. The second portion of the meander preventing rollers 510 may be disposed an end or both ends of the rotation shaft 511. The first portion of the meander preventing rollers 510 may be disposed at a center portion of the rotation shaft 511 or between second portions of the meander preventing rollers 510.

The elastic member 520 may be a spring to elastically press the meander preventing roller 510 towards a center of the fixing belt 200, that is, a center of the rotation path in the axial direction, and a second end 511 b of the rotation shaft 511 of the meander preventing roller 510 may be fitted into the elastic member 520. Although the elastic member 520 described with regard to the exemplary embodiment of the present general inventive concept is a coil spring, the elastic member 520 can be implemented in various forms, such as a leaf spring or the like. A fixing bracket 530 may be provided to support the outside of the elastic member 520 so that the elastic member 520 can elastically press the meander preventing roller 510 towards the center of the fixing belt 200, and to prevent the elastic member 520 from deviating from one end portion of the guide member 400. The fixing bracket 530 may be securely fastened to one side of the guide member 400 by a screw (not illustrated).

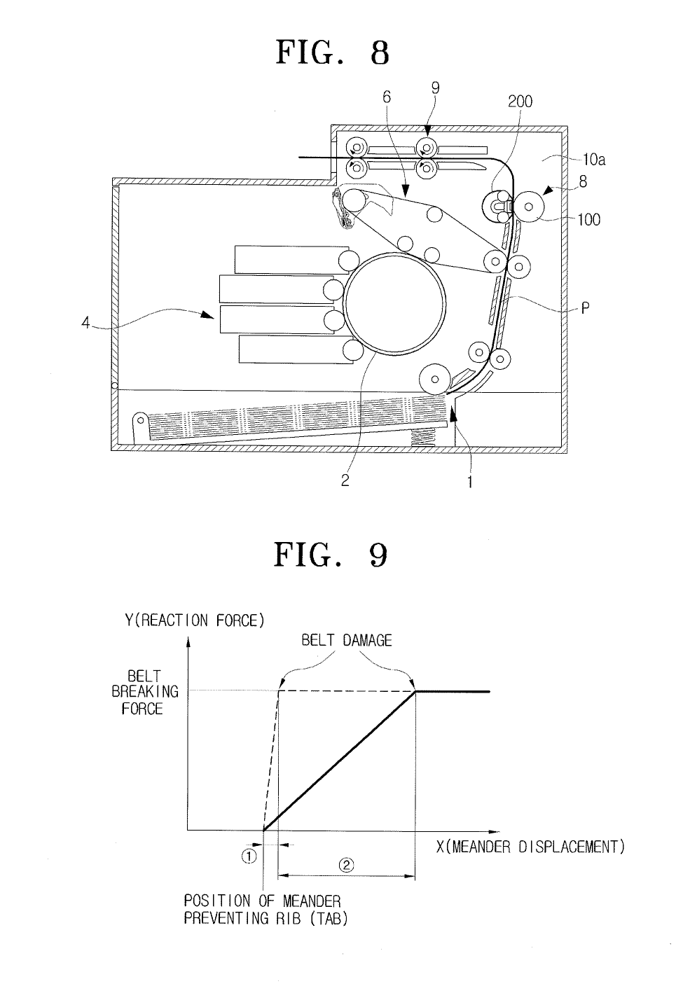

The fixing bracket 530 may be disposed on or connected to a housing 10a of the image forming apparatus (FIG. 8) to correspond to the meander preventing roller 510. The housing 10a of the image forming apparatus (FIG. 8) may be provided in plural to support the fixing bracket with respect to the guide member 400 and the fixing belt 200. The fixing bracket 530 may be fixedly mounted on the housing 10a of the image forming apparatus. It is possible that the fixing bracket 530 may be movably disposed on the housing 10a of the image forming apparatus. It is also possible that one of the housing 10a of the image forming apparatus may have a structure to hold the fixing bracket 530 with respect to the meander preventing roller 510. The fixing bracket 530 can have one or more grooves 520a to receive the elastic member 520 connected to the second end 511b of the rotation shaft 511 of the meander preventing roller 510.

As illustrated in FIG. 8, an image forming apparatus according to an exemplary embodiment of the present general inventive concept includes a feeding device 1, a photoconductive medium 2; a developing device 4 to attach a developer onto an electrostatic latent image on the photoconductive medium 2 and to develop the electrostatic latent image, a transferring device 6 to transfer an image developed on the photosensitive medium 2 by the developing device 4 to a printing medium P, a fixing device 8 to fix the image transferred to the printing medium P, and a discharging device 9. The feeding device 1, the photoconductive medium 2, the developing device 4, the transferring device 6 and the discharging device 9 are known to those skilled in the art, so more detailed descriptions thereof are omitted. The fixing device 1 may be configured according to the exemplary embodiments as described above.

As described above, according to the exemplary embodiment of the present general inventive concept, the fixing device, applies heat and pressure onto a non-fixed toner image transferred onto a surface of a sheet of paper P by a transferring device known to those skilled in the art, while the sheet of paper P passes through a nip N formed by pressure contact between the fixing roller 100 and the fixing belt 200 which rotate in contact with each other, and then fuses the toner image onto the sheet of paper P. The fixing belt 200, which rotates in tight contact with the fixing roller 100 as described above, may come into irregular contact with the guide member 400. Accordingly, the fixing belt 200 may be skewed along an axis of the guide member 400 due to the irregular contact, that is, may meander. The sides of the fixing belt 200 may be pressed by the rib 510a of the meander preventing roller 510, and thus meandering of the fixing belt 200 can be prevented. Additionally, the meander preventing roller 510 may be elastically supported by the elastic member 520 along its axis, so a reaction force acting on the end portion of the fixing belt 200 may be smoothly absorbed. Accordingly, it is possible to prevent the fixing belt 200 from being crumpled or damaged.

FIG. 9 is a graph illustrating a difference between the meander preventing effect of a fixing device according to an exemplary embodiment of the present general inventive concept and a conventional fixing device. In FIG. 9, a solid line indicates the effect of preventing the belt from meandering in the fixing device according to the exemplary embodiment of the present general inventive concept, and a dotted line indicates the effect of preventing the belt from meandering in the conventional fixing device.

In the conventional fixing device having the meander preventing function illustrated in FIG. 9, since a space \textcircled{1} in which the meander preventing force acts based on the elastic force of the fixing belt 200 when the belt meanders during image fixing is narrow, and the reaction force acting on the end portion of the fixing belt 200 is large, the fixing belt 200 may easily be crumpled or damaged. On the other hand, in the fixing device having the meander preventing function according to the exemplary embodiment of the present general inventive concept, a space \textcircled{1}+\textcircled{2}, in which a meander preventing force acts based on the elastic force of the fixing belt 200 and the elastic member 520 when the belt meanders during image fixing is wide, and the reaction force acting on the end portion of the fixing belt 200 is gently absorbed, and thus it is possible to protect the fixing belt 200 from being crumpled or damaged.

The fixing device according to the exemplary embodiment of the present general inventive concept includes the guide rollers 410 mounted on the guide member 400 to rotate in contact with the inside surface of the fixing belt 200, and accordingly it is possible to minimize friction caused by contact with the inside of the fixing belt 200.

Additionally, the nip spring 420 including the heat source 300 may be integrally engaged with the guide member 400 using the fastener 430 such as the screw 431 or clip 432. The fixing device enables the nip spring 420 made of a metallic material to slide slightly along the axis of the guide member 400, and thus it is possible to prevent the nip spring 420 from becoming thermally deformed.

As described above, according to the exemplary embodiments of the present general inventive concept, the sides of the fixing belt is elastically supported to smoothly absorb the reaction force acting on the end portion of the fixing belt, so it is possible to prevent the fixing belt from being damaged and meandering.

Additionally, the fixing device according to the exemplary embodiment of the present general inventive concept includes guide rollers to rotate in contact with the inside surface of the fixing belt, and thus it is possible to minimize friction caused by the contact with the inside of the fixing belt.

The fixing device according to the exemplary embodiment of the present general inventive concept also includes a nip spring to elastically support the nip zone. The nip spring can be elastically deformed to have a shape equivalent to the shape of the pressing roller, and the pressurizing force acting on the pressing roller can be adjusted.

Moreover, the nip spring includes a heat source and is integrally fastened to the guide member using a fastener such as a screw or a clip, so it is possible to prevent the nip spring made of a metallic material from being thermally deformed.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A fixing device usable with an image forming apparatus, comprising:
a fixing roller;
a fixing belt to rotate by a rotation force transferred from the fixing roller;
a heat source mounted inside the fixing belt;
a guide member mounted inside the fixing belt to guide the rotation of the fixing belt; and
a belt meander preventing unit mounted on the guide member to elastically support one or more sides of the fixing belt and to prevent the fixing belt from meandering.

2. The fixing device as claimed in claim 1, wherein the belt meander preventing unit comprises:
one or more meander preventing rollers which are mounted on one or both ends of the guide member; and
an elastic member to elastically press the one or more meander preventing rollers towards the center of the fixing belt.

3. The fixing device as claimed in claim 2, wherein the one or more meander preventing rollers comprise one of a rib and a tab protruding from an outside surface thereof to prevent the fixing belt from meandering.

4. The fixing device as claimed in claim 2, wherein the one or more meander preventing rollers move along an axis of a certain portion of the guide member.

5. The fixing device as claimed in claim 4, wherein the one or more meander preventing rollers are rotatably mounted on a certain portion of the guide member.

6. The fixing device as claimed in claim 2, wherein the one or more meander preventing rollers are arranged symmetrically or asymmetrically on an outer surface of a certain portion of the guide member.

7. The fixing device as claimed in claim 1, wherein the guide member comprises one or more guide rollers mounted thereon to rotate in contact with an inside surface of the fixing belt.

8. The fixing device as claimed in claim 7, wherein the one or more guide rollers are arranged symmetrically or asymmetrically on an outer surface of a certain portion of the guide member.

9. The fixing device as claimed in claim 1, wherein the guide member comprises a nip forming unit to support the fixing belt so that a nip zone is formed in a contact area between the fixing roller and the fixing belt.

10. The fixing device as claimed in claim 9, wherein the nip forming unit is formed of an elastic body with a predetermined elasticity.

11. The fixing device as claimed in claim 10, wherein the nip forming unit comprises a nip spring.

12. The fixing device as claimed in claim 11, wherein the nip spring is made of a metallic material.

13. The fixing device as claimed in claim 11, wherein the nip spring is integrally engaged with the guide member using a fastener.

14. The fixing device as claimed in claim 13, wherein the fastener comprises a plurality of fasteners disposed at fixed intervals along the axis of the guide member.

15. The fixing device as claimed in claim 13, wherein the fastener is one of a screw and a clip.

16. The fixing device as claimed in claim 11, wherein the heat source is disposed on either or both the inside and the outside of the nip spring.

17. The fixing device as claimed in claim 11, further comprising:
a heat insulating member mounted between the nip spring and the guide member.

18. The fixing device as claimed in claim 1, wherein the fixing roller is a pressing roller.

19. A fixing device usable with an image forming apparatus, comprising:
a pressing roller;
a fixing belt which is made to rotate by a rotation force transferred from the pressing roller;
a heat source which is mounted inside the fixing belt; and
a belt meander preventing unit to elastically support both sides of the fixing belt and to prevent the fixing belt from meandering.

20. An image forming apparatus comprising:
a photoconductive medium;
a developing device to attach a developer onto an electrostatic latent image on the photoconductive medium and to develop the electrostatic latent image;
a transferring device to receive and transfer an image developed on the photosensitive medium by the developing device to a printing medium; and
a fixing device to fix the image transferred to the printing medium,
wherein the fixing device comprises:
a fixing roller;
a fixing belt to rotate by a rotation force transferred from the fixing roller;
a heat source mounted inside the fixing belt;
a guide member mounted inside the fixing belt to guide the rotation of the fixing belt; and
a belt meander preventing unit mounted on the guide member to elastically support one or more sides of the fixing belt and to prevent the fixing belt from meandering.

21. The image forming apparatus as claimed in claim 20, wherein the belt meander preventing unit comprises:
one or more meander preventing rollers which are mounted on one or both ends of the guide member; and
an elastic member to elastically press the one or more meander preventing rollers towards the center of the fixing belt.

22. The image forming apparatus as claimed in claim 21, wherein:
the one or more meander preventing rollers comprise one of a rib and a tab protruding from an outside surface thereof to prevent the fixing belt from meandering; and
the one or more meander preventing rollers are rotatably mounted on a certain portion of the guide member, and are arranged symmetrically or asymmetrically on an outer surface of a certain portion of the guide member.

23. The image forming apparatus as claimed in claim 20, wherein:
the guide member comprises one or more guide rollers mounted thereon to rotate in contact with an inside surface of the fixing belt, and a nip forming unit to support the fixing belt so that a nip zone is formed in a contact area between the fixing roller and the fixing belt; and
the one or more guide rollers are arranged symmetrically or asymmetrically on an outer surface of a certain portion of the guide member.

24. The image forming apparatus as claimed in claim 23, wherein the nip forming unit is formed of an elastic body with a predetermined elasticity.

25. The image forming apparatus as claimed in claim 24, wherein the nip forming unit comprises a nip spring made of a metallic material, and is integrally engaged with the guide member using a fastener.

26. The image forming apparatus as claimed in claim 25, wherein a plurality of fasteners are disposed at fixed intervals along an axis of the guide member, and are one of a screw and a clip.

27. The image forming apparatus as claimed in claim 25, wherein the heat source is disposed on either or both the inside and the outside of the nip spring, and a heat insulating member is mounted between the nip spring and the guide member.

28. An image forming apparatus comprising:
a photoconductive medium;
a developing device to attach a developer onto an electrostatic latent image on the photoconductive medium and to develop the electrostatic latent image;
a transferring device to receive and transfer an image developed on the photosensitive medium by the developing device to a printing medium; and
a fixing device to fix the image transferred to the printing medium,
wherein the fixing device comprises:
a pressing roller;
a fixing belt which is made to rotate by a rotation force transferred from the pressing roller;
a heat source which is mounted inside the fixing belt; and
a belt meander preventing unit to elastically support both sides of the fixing belt and to prevent the fixing belt from meandering.

29. A fixing device usable with an image forming apparatus, comprising:
a guide member to guide the rotation of the fixing belt; and
a belt meander preventing device having one or more meander preventing rollers mounted on one or both ends of the guide member, and an elastic member to elastically press the one or more meander preventing rollers towards a center of the fixing belt.
